(19) United States
(12) Patent Application Publication
(10) Pub. No.: US 2008/0140706 A1
(43) Pub. Date: Jun. 12, 2008

(54) Image retrieval system

(76) Inventor: Charles Kahn, Milwaukee, WI (US)

Correspondence Address: REED SMITH LLP, Suite1400, 3110 Fairview Park Drive, Falls Church, VA, 22042, US

(21) Appl. No.: 11/987,095

(22) Filed: Nov. 27, 2007

Related U.S. Application Data
(60) Provisional application No. 60/861,101, filed on Nov. 27, 2006.

(51) Int. Cl. G06F 17/30

(52) U.S. Cl. 707/103 R; 707/E17.001

(57) ABSTRACT

A method comprises collecting an online article which includes a figure from selected online sources, recording data identifying the online article, creating a thumbnail image of each figure, storing it and a figure caption associated with the figure in a database, indexing a text of the figure caption by keywords and concepts determined by Metathesaurus®, determining a concept of a search term by Metathesaurus®, identifying a figure caption by comparing the search term with the keywords indexing a text of each figure caption and the concept of the search term with the concepts indexing a text of each figure caption, retrieving a thumbnail image associated with the identified figure caption, displaying the retrieved thumbnail image and the identified figure caption, and providing a link to an online article including the identified figure caption with the retrieved thumbnail image. Search results are filtered based on age, sex and modality.

### FIELD OF INVENTION

The invention generally relates to methods and systems for searching medical images published in online articles.

### BACKGROUND OF THE INVENTION

Images published in peer-reviewed radiology journals serve as a valuable source of information for medical education and clinical decision support. Although the articles in which the figures appear are indexed by Medical Subject Headings (MeSH) codes, the more granular information in the individual figures requires additional information for satisfactory search and retrieval.

Search engines provided by Google and Yahoo! do not automatically limit the materials to be searched to peer-reviewed radiology materials. Therefore, the quality of the images in the search result obtained by these search engines does not meet the demands of the audience in the medical field unless the search sources are specified. Also, these search engines do not understand complex medical terminology. In the medical field, the same or equivalent meaning is often described by different terms. However, the above-mentioned search engines do not understand hierarchical relationships among the medical terms which are relevant to each other. Images in many teaching files are often indexed only by textual keywords, and are not indexed for retrieval by controlled vocabulary, such as Medical Subject Headings (MeSH). Consequently, the search result cannot have high relevancy with a search term provided by a user, and too many or too few results are obtained by these search engines.

### SUMMARY OF THE INVENTION

The overall objective of the present invention is to create a digital library of radiological images that can be accessed readily for education and clinical decision making. One objective of the present invention is to improve the reliability of search results by limiting the materials to be searched to peer-reviewed materials in the medical field. Another objective of the present invention is to provide search engines suitable in the medical field by performing keyword-based search and concept-based search. Another objective of the present invention is to provide an easy-to-use search interface for access to a large pool of figures and associated text. Another objective of the present invention is to identify figures by a patient's age and sex and imaging modality. Another objective of the present invention is to enable the users to limit their search by imaging modality and by patient age and sex. By indexing the captions of figures in the radiological literature, particularly online articles, the image library provides information about the images that is more granular than indexing by PubMed or other search engines.

The present invention provides a method for retrieving images from online journals, comprising the steps of: selecting online sources that publish online articles; collecting an online article which includes a figure from the selected online sources; recording data identifying the collected online article; creating a thumbnail image of at least a part of the figure; storing the thumbnail image and a figure caption associated with the figure in a database; indexing a text of the figure caption by keywords; indexing the text of the figure caption by concepts obtained by using a thesaurus in a Unified Medical Language System; providing a search term; determining a concept of the search term by using the thesaurus in the Unified Medical Language System; identifying a first figure caption, at least one of keywords indexing a text of the first figure caption corresponding to the search term; retrieving from the database a first thumbnail image associated with the first figure caption; identifying a second figure caption, at least one of concepts indexing a text of the a second figure caption corresponding to the concept of the search term; retrieving from the database a second thumbnail image associated with the second figure caption; displaying the retrieved first thumbnail image, at least a part of the first figure caption, the retrieved second thumbnail image, and at least a part of the second figure caption; and providing a link to an online article which includes the first figure caption with the first thumbnail image and a link to an online article which includes the second figure caption with the second thumbnail image.

Alternatively, the present invention further provides that the above-mentioned method further comprises the steps of: providing each keyword index code corresponding to each keyword indexing a text of each figure caption included in each collected online article, providing each concepts index code corresponding to each concept indexing the text of each figure caption included in each collected online article; providing a search term code corresponding to the search term; and providing a concept search term code corresponding to the concept of the search term, wherein the first figure caption is identified by comparing the search term code with the each keyword index code indexing the text of each figure caption included in each collected online article, and the second figure caption is identified by comparing the concept search term code with each concept index code indexing the text of each figure caption included in each collected online article.

Alternatively, the present invention further provides that the above-mentioned method further comprises the steps of: determining at least one of an age and a sex of a subject of the figure using the figure caption; determining imaging modality corresponding to the figure using the figure caption; storing the at least one of the age and the sex determined and the determined imaging modality in the database; determining a filtering parameter, the filtering parameter comprising at least one of an age range, a sex, and imaging modality; filtering the first thumbnail image and second thumbnail image based on the filtering parameter; and displaying filtered thumbnail image.

Alternatively, the present invention further provides that the above-mentioned method further comprises the steps of: determining a first value indicating relevancy between the search term and the at least one of keywords indexing the text of the first figure caption; determining a second value indicating relevancy between the concept of the search term and each concept indexing the second figure caption; determining a rank of relevancy of each of the retrieved first thumbnail image and second thumbnail image based on the first value and the second value; and displaying the retrieved first thumbnail image and second thumbnail image according to the determined ranks.

### BRIEF DESCRIPTION OF THE DRAWINGS

FIG. 1 illustrates a database of the online sources used in the present invention.

FIG. 2 illustrates the features of indexing a figure caption associated with the figure including an image by keywords and concepts.

FIG. 3 illustrates a flow diagram for searching an image based on keywords and concepts.

FIG. 4 shows an exemplary display of retrieved thumbnail images and their corresponding figure caption.

FIG. 5 shows an exemplary display of retrieved thumbnail images and their corresponding figure caption.

FIG. 6 shows an exemplary filter interface.

FIG. 7 illustrates a block diagram of the system in the present invention.

FIG. 8 shows a result of concept-based indexing.

### DETAILED DESCRIPTION

### A. Database of Figures and Figure Captions

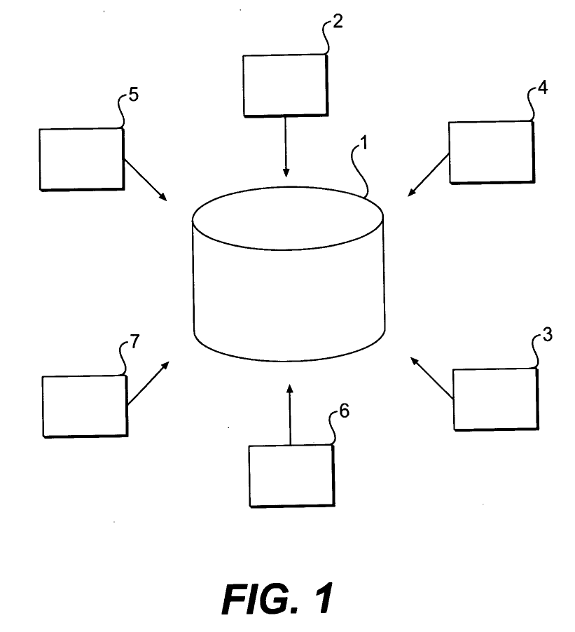

Several large radiology societies including the American Roentgen Ray Society, the American Society of Neuroradiology, the British Institute of Radiology, and the Radiological Society of North America make the content of their journals available through the Web twelve to twenty four months after publications. Open access content or online articles from selected peer-reviewed radiology journals published by such societies are incorporated as online sources. FIG. 1 illustrates an exemplary database 1 of the online sources to create a virtual image library. For example, open access content published in the peer-reviewed journals, AJR 2, American Journal of Neuroradiology 3, Radiology 4, British Journal of Radiology 5, and RadioGraphics 7 are incorporated as online sources. These selected journals are written in English and are hosted online by HighWire Press, a division of Stanford University Libraries. Content from the European Association of Radiology's EURORAD E-Learning Initiative 6, which comprises more than 1900 peer-reviewed case reports with high-quality images, may be incorporated as the online sources. Content of the peer-reviewed journals which are not openly accessed may be incorporated also as online sources. Collected figures from these online sources and data corresponding to the figures and the online sources are stored in, for example, a MySQL database (version 4.1; MYSQL AB, www.mysql.net). Software is written, in for example, the PHP programming language.

A web robot or software is created to harvest and collect figure captions from these online sources. For each article, the system records at least one of a title of the online article, a name of the journal in which the online article is published, an uniform resource locator (URL) of the full-text online article, and a digital object identifier (DOI), a PubMed identifier (PMID) and a MeSH code of the online article. MeSH is a controlled vocabulary for indexing articles of the journals and books in the life sciences. MeSH codes are obtained from Medline using the National Library of Medicine's eQuery and eFetch web-based utilities. MeSH codes assigned by EURORAD to index its content are captured by the harvesting software. A small and low-resolution thumbnail image of a figure or a figure part associated with each collected figure caption is created and stored in the database. Each figure caption associated with each figure is also stored in the database.

### B. Indexing a Figure Caption

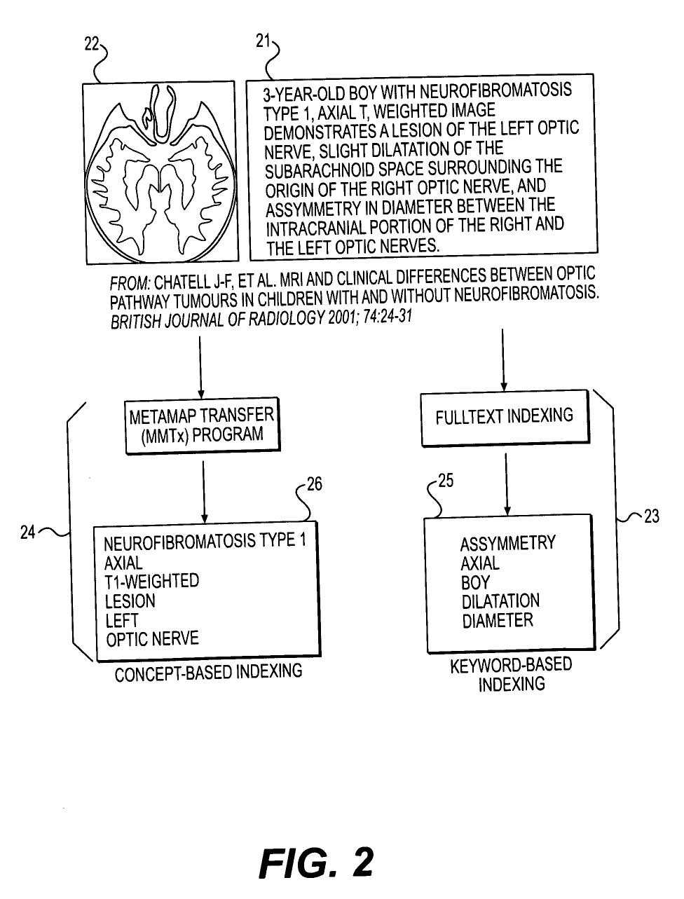

Each figure caption harvested by the web robot is indexed by keywords and concepts, respectively. FIG. 2 illustrates the features of indexing a figure caption 21 associated with a FIG. 22 by keywords and concepts. In the keyword-based indexing 23, the full text of the figure caption 21 is indexed by keywords 25. In the concept-based indexing 24, the National Library of Medicine's MetaMap Transfer (MMTx) software is used to map the caption's unstructured text to concepts 26 in a thesaurus provided in the Unified Medical Language System (UMLS), namely, Metathesaurus®. MMTx uses natural language processing and computational linguistic techniques to discover concepts from structured vocabularies within the unstructured text. MMTx maps each figure's caption to pertinent concepts in the UMLS Metathesaurus®, version 2004AA. The keywords and concepts indexing each figure caption are stored associated with the corresponding thumbnail image in the database. Alternatively, keyword index codes corresponding to the keyword and concept index codes corresponding to the concepts may be provided. These codes may be stored in the database. Although a moderate amount of customized programming is required to prepare the figure captions for processing, MMTx functions autonomously without the need for manual curation or human decision-making. The Metathesaurus® provides the “medical intelligence” to understand synonymy and hierarchy among the indexed terms. The RadLex vocabulary for radiology can be also applied to further index the database's content.

### C. Searching an Image

The search engine performs two retrieval techniques, namely, keyword-based search and concept-based search. The keyword-based search is a case sensitive string. For example, the search term “gallstone” matches any figure with a caption that contained the word “gallstone,” “Gallstone,” or “GALLSTONE.” It would not, however, match text that contained “gall stone,” which consists of two words or “gallstones,” which is in the plural form. The second, more powerful, technique is the concept-based search. With this technique, the knowledge contained in the UMLS Metathesaurus® is used to search using the meaning of the specified term or a keyword. The Metathesaurus® contains lexical variants of terms, such as “gallstone” and “gallstones.” The Metathesaurus® also contains synonyms, such as “cholelithiasis.” The Metathesaurus® also recognizes that “gallstones” is a subtype of “gallbladder disease.” Thus, when a user enters “gallstone” as a search term, images labeled with “gallstone, “gallstones,” and “cholelithiasis” are retrieved.

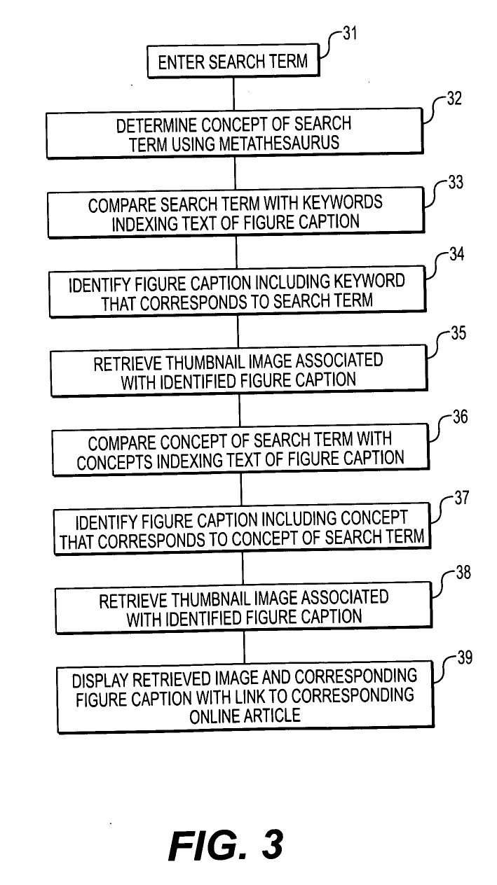

A simple Web-based user interface is created to facilitate searching. FIG. 3 illustrates a flow diagram for searching an image based on keywords and concepts. The search term is entered by the user in a query (Step 31). One or more concepts of the search term are determined using (UMLS) Metathesaurus® (Step 32). The concepts of the search term may comprise at least one of a lexical variant of the term, a synonym of the term, an abbreviation of the term, and a kind of a disease related to the term. Alternatively, a search term code corresponding to the search term and a concept search term code corresponding to the concept of the search term may be provided. In the keyword-based searching, a first figure caption is identified where at least one of the keywords indexing a text of the first figure caption corresponds to the term (Steps 33-34). A first thumbnail image associated with the identified first figure caption is retrieved (Step 35). In the concept-based searching, a second figure caption is identified where at least one of concepts indexing a text of the second figure caption corresponds to one or more concepts of the search term is identified (Steps 36-37). A second thumbnail image associated with the identified figure caption is retrieved (Step 38). The first figure caption may be identified by comparing the search term code with the keyword index codes. The second figure caption may be identified by comparing the concept search term codes with the concept index codes. The retrieved thumbnail image and at least a part of the corresponding figure caption are displayed on the monitor (Step 39). Combination of these two search strategies is very effective. For example, none of the vocabularies in the Metathesaurus® includes the concept of “Mirizzi syndrome,” which is a gallstone impacted in the cystic duct that obstructs the extrahepatic bile duct. However, thirteen images with captions that contain the words “Mirizzi” and “syndrome’ are found by the keyword-based search. Conversely, although none of the figure captions indexed contains the word “phakomatosis,” seventy five images are identified matching that term by the concept-based search, because the terms such as “neurofibromatosis,” “von Recklinghausen's disease,” and “tuberous sclerosis” are recognized as subtypes of the concept of phakomatosis by the knowledge from the Metathesaurus®.

### D. Displaying

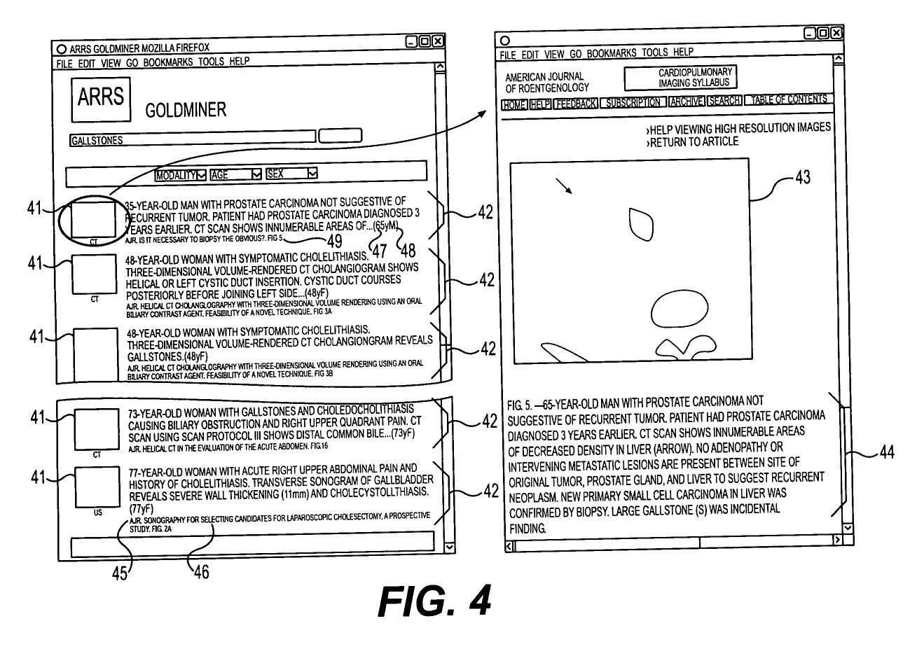

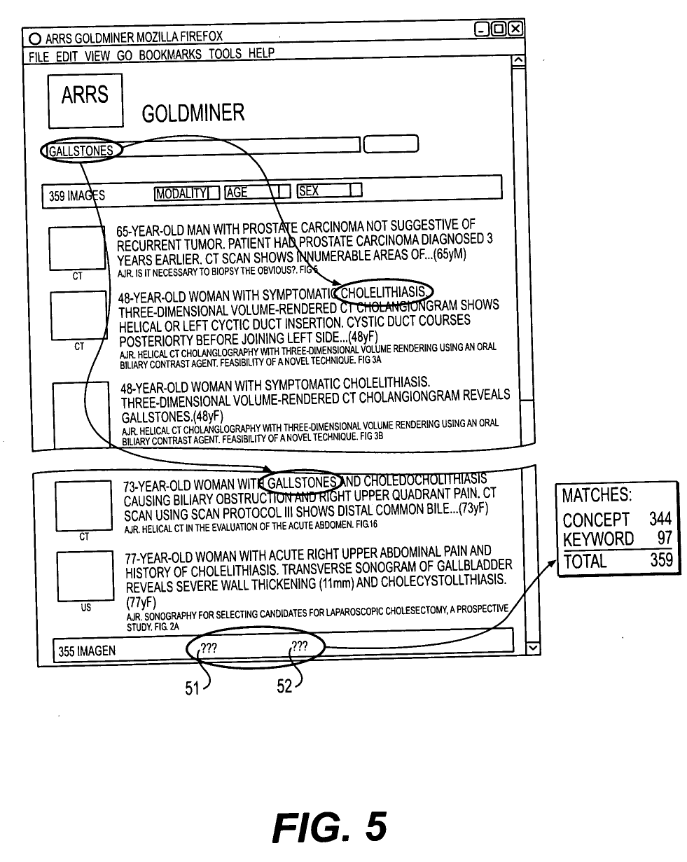

FIG. 4 shows an exemplary display of retrieved thumbnail images 41 and at least a part of the corresponding figure captions 42. Each thumbnail image points to the original figure at its source Website. Thus, by clicking on a figure, a user can link to the original full-resolution image 43 and its complete figure caption 44. The source 45 and title 46 of the article from which each retrieved image is derived may be also displayed. The title may be linked to the full-text article at the original Website. The age 47 and the sex 48 of the retrieved image's subject and imaging modality of the retrieved image may be also displayed. Also, the figure number 49 of the retrieved image in its source article may be displayed. Also, each number 52, 51 of the results by the keyword-based search and the concept-based search may be displayed as shown in FIG. 5.

### D. Filtering

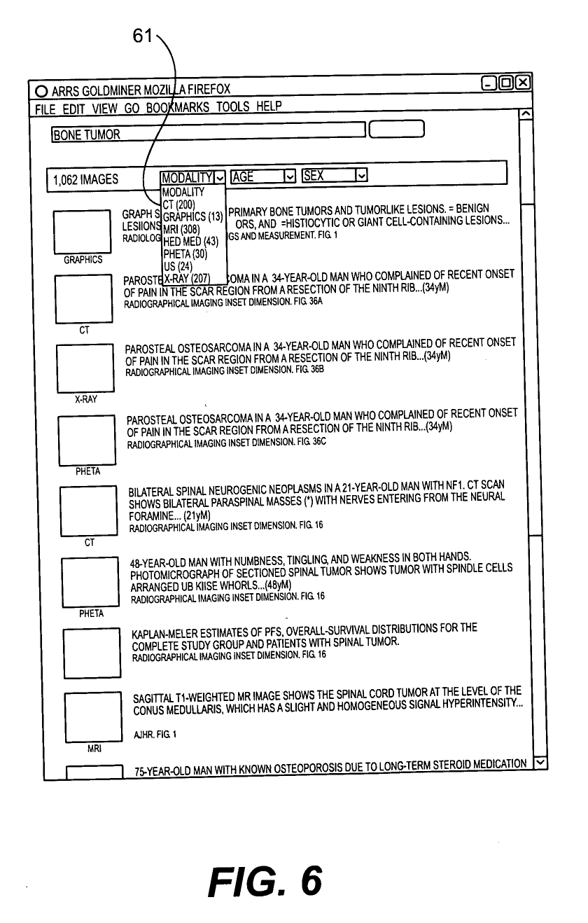

Search results may be filtered by at least one of filtering parameters, namely, imaging modality, age groups, and/or, sexes. The patient's age and sex are parsed from the figure caption, determined, and stored in the database. The imaging modality is determined based on a frequency of the appearance of a word indicating imaging modality in the figure caption. The filters are presented as a set of pull-down tabs 61 at the top of the search page as shown in FIG. 6. Each tab lists the available selections as a filtering parameter and the number of corresponding images. Users can apply one or more of the filters as needed. For example, the user can search for “breast cancer,” and then, limit the search to male subjects. Imaging modality includes radiography, CT, MRI, sonography, PET, nuclear medicine and categories for photos such as photomicrographs and endoscopic images, and graphics such as charts and illustrations. Patients may be grouped by age as infants (<2 years), children (2-17 years), or adults (≧18 years).

### E. System

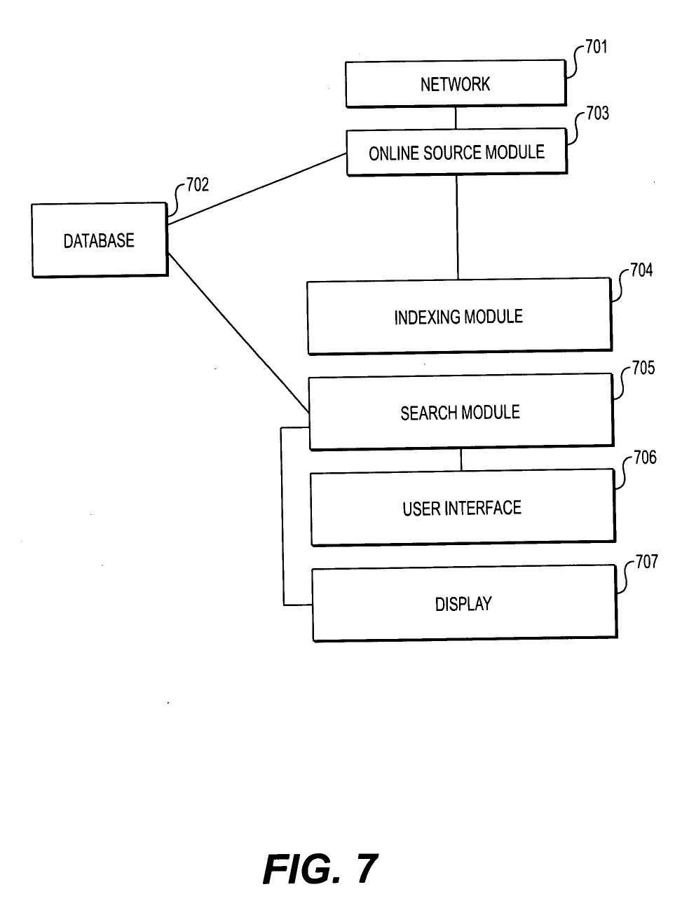

FIG. 7 illustrates a block diagram of the system for retrieving images from online journals. The system comprises a database 702, an online source module 703, an indexing module 704, a search module 705, a user interface 706, and a display 707. The online source module 703 is configured to select online sources that publishes online articles, collect an online article which includes a figure from the selected online sources via a network 702, record data identifying the collected online article, create a thumbnail image of at least a part of the figure, store the thumbnail image and a figure caption associated with the figure in a database. The indexing module 704 is configured to index a text of the figure caption by keywords and index the text of the figure caption by concepts obtained by using a thesaurus in a Unified Medical Language System. The user interface 706 is configured to provide a search term. The search module 705 is configured to determine a concept of the search term by using the thesaurus in the Unified Medical Language System, identify a first figure caption, at least one of keywords indexing a text of the first figure caption corresponding to the search term, retrieve from the database a first thumbnail image associated with the first figure caption, identify a second figure caption, at least one of concepts indexing a text of the second figure caption corresponding to the concept of the search term, retrieve from the database a second thumbnail image associated with the second figure caption, and provide a link to an online article which includes the first figure caption with the first thumbnail image and a link to an online article which includes the second figure caption with the second thumbnail image. The display 707 displays the retrieved first thumbnail image, at least a part of the first figure caption, the retrieved second thumbnail image, and at least a part of the second figure caption.

Alternatively, the index module may provide each keyword index code corresponding to each keyword indexing a text of each figure caption included in each collected online article, and provide each concepts index code corresponding to each concept indexing the text of each figure caption included in each collected online article. The search module is configured to further provide a search term code corresponding to the search term, and prove a concept search term code corresponding to the concept of the search term. The first figure caption is identified by comparing the search term code with the each keyword index code indexing the text of each figure caption included in each collected online article, and the second figure caption is identified by comparing the concept search term code with each concept index code indexing the text of each figure caption included in each collected online article.

Alternatively, the online source module may determine at least one of an age and a sex of a subject of the figure using the figure caption, determine imaging modality corresponding to the figure using the figure caption, store the at least one of the age and the sex determined and the determined imaging modality in the database. The user interface may enter a filtering parameter, the filtering parameter comprising at least one of an age range, a sex, and imaging modality. The search module may filter the first thumbnail image and second thumbnail image based on the filtering parameter. The display may display a filtered thumbnail image.

Alternatively, the search module may determine a first value indicating relevancy between the search term and the at least one of keywords indexing the text of the first figure caption, determine a second value indicating relevancy between the concept of the search term and each concept indexing the second figure caption, and determine a rank of relevancy of each of the retrieved first thumbnail image and second thumbnail image based on the first value and the second value. The display may display the retrieved first thumbnail image and second thumbnail image according to the determined ranks.

Alternatively, the data identifying the online article comprises at lease one of a title of the online article, a name of a journal in which the online article is published, an uniform resource locator of the online article, a digital object identifier of the online article, a PubMed identifier of the online article, and a MeSH code of the online article.

Alternatively, the search term is selected from terms indicating findings, diseases, anatomy, imaging modality, ages, and sexes.

Alternatively, the imaging modality is determined based on a frequency of appearances of a word in the figure caption, the word indicating imaging modality.

### F. Experiment Results.

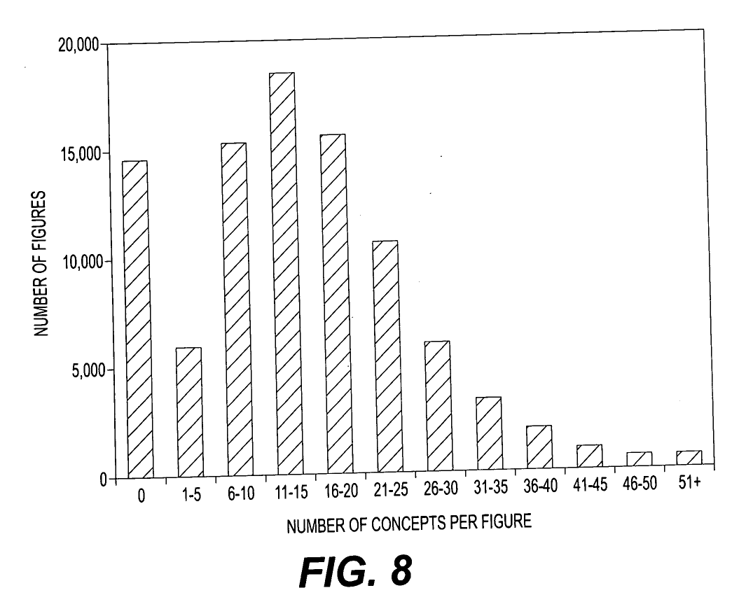

FIG. 8 shows a result of concept-based indexing. A total of 10,766 articles and 82,566 figures were collected from the six online sources. Images were classified by imaging modality based on their captions in 83.3 percent of cases. Photographs and graphics (charts, drawings, and other illustrations) comprised 4.4 percent of the collection. The patient's age and/or sex were identified for 60.8 percent of the images in the collection based on information in the figure caption.

Although the present invention has been fully described in connection with the preferred embodiment thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A method for retrieving images from online journals, comprising the steps of:
selecting online sources that publish online articles;
collecting an online article which includes a figure from the selected online sources;
recording data identifying the collected online article;
creating a thumbnail image of at least a part of the figure;
storing the thumbnail image and a figure caption associated with the figure in a database;
indexing a text of the figure caption by keywords;
indexing the text of the figure caption by concepts obtained by using a thesaurus in a Unified Medical Language System;
providing a search term;
determining a concept of the search term by using the thesaurus in the Unified Medical Language System;
identifying a first figure caption, at least one of keywords indexing a text of the first figure caption corresponding to the search term;
retrieving from the database a first thumbnail image associated with the first figure caption;
identifying a second figure caption, at least one of concepts indexing a text of the a second figure caption corresponding to the concept of the search term;
retrieving from the database a second thumbnail image associated with the second figure caption;
displaying the retrieved first thumbnail image, at least a part of the first figure caption, the retrieved second thumbnail image, and at least a part of the second figure caption; and
providing a link to an online article which includes the first figure caption with the first thumbnail image and a link to an online article which includes the second figure caption with the second thumbnail image.

2. The method according to claim 1, further comprising the steps of:
providing each keyword index code corresponding to each keyword indexing a text of each figure caption included in each collected online article,
providing each concepts index code corresponding to each concept indexing the text of each figure caption included in each collected online article;
providing a search term code corresponding to the search term; and
providing a concept search term code corresponding to the concept of the search term,
wherein the first figure caption is identified by comparing the search term code with the each keyword index code indexing the text of each figure caption included in each collected online article, and the second figure caption is identified by comparing the concept search term code with each concept index code indexing the text of each figure caption included in each collected online article.

3. The method according to claim 1, further comprising the steps of:
determining at least one of an age and a sex of a subject of the figure using the figure caption;
determining imaging modality corresponding to the figure using the figure caption;
storing the at least one of the age and the sex determined and the determined imaging modality in the database;
determining a filtering parameter, the filtering parameter comprising at least one of an age range, a sex, and imaging modality;
filtering the first thumbnail image and second thumbnail image based on the filtering parameter; and
displaying filtered thumbnail image.

4. The method according to claim 1, further comprising the steps of:
determining a first value indicating relevancy between the search term and the at least one of keywords indexing the text of the first figure caption;
determining a second value indicating relevancy between the concept of the search term and each concept indexing the second figure caption;
determining a rank of relevancy of each of the retrieved first thumbnail image and second thumbnail image based on the first value and the second value; and
displaying the retrieved first thumbnail image and second thumbnail image according to the determined ranks.

5. The method according to claim 1, wherein the data identifying the online article comprises at lease one of a title of the online article, a name of a journal in which the online article is published, an uniform resource locator of the online article, a digital object identifier of the online article, a PubMed identifier of the online article, and a MeSH code of the online article.

6. The method according to claim 1, wherein the search term is selected from terms indicating findings, diseases, anatomy, imaging modality, ages, and sexes.

7. The method according to claim 3, wherein the imaging modality is determined based on a frequency of appearances of a word in the figure caption, the word indicating imaging modality.

8. A computer program implemented on a computer-readable medium for retrieving images from online journals, comprising the steps of:
selecting online sources that publish online articles;
collecting an online article which includes a figure from the selected online sources;
recording data identifying the collected online article;
creating a thumbnail image of at least a part of the figure;
storing the thumbnail image and a figure caption associated with the figure in a database;
indexing a text of the figure caption by keywords;
indexing the text of the figure caption by concepts obtained by using a thesaurus in a Unified Medical Language System;
providing a search term;
determining a concept of the search term by using the thesaurus in the Unified Medical Language System;
identifying a first figure caption, at least one of keywords indexing a text of the first figure caption corresponding to the search term;
retrieving from the database a first thumbnail image associated with the first figure caption;
identifying a second figure caption, at least one of concepts indexing a text of the a second figure caption corresponding to the concept of the search term;
retrieving from the database a second thumbnail image associated with the second figure caption;
displaying the retrieved first thumbnail image, at least a part of the first figure caption, the retrieved second thumbnail image, and at least a part of the second figure caption; and
providing a link to an online article which includes the first figure caption with the first thumbnail image and a link to an online article which includes the second figure caption with the second thumbnail image.

9. The computer program according to claim 8, further comprising the steps of:
providing each keyword index code corresponding to each keyword indexing a text of each figure caption included in each collected online article,
providing each concepts index code corresponding to each concept indexing the text of each figure caption included in each collected online article;
providing a search term code corresponding to the search term; and
providing a concept search term code corresponding to the concept of the search term,
wherein the first figure caption is identified by comparing the search term code with the each keyword index code indexing the text of each figure caption included in each collected online article, and the second figure caption is identified by comparing the concept search term code with each concept index code indexing the text of each figure caption included in each collected online article.

10. The computer program according to claim 8, further comprising the steps of:
determining at least one of an age and a sex of a subject of the figure using the figure caption;
determining imaging modality corresponding to the figure using the figure caption;
storing the at least one of the age and the sex determined and the determined imaging modality in the database;
determining a filtering parameter, the filtering parameter comprising at least one of an age range, a sex, and imaging modality;
filtering the first thumbnail image and second thumbnail image based on the filtering parameter; and
displaying filtered thumbnail image.

11. The computer program according to claim 8, further comprising the steps of:
determining a first value indicating relevancy between the search term and the at least one of keywords indexing the text of the first figure caption;
determining a second value indicating relevancy between the concept of the search term and each concept indexing the second figure caption;
determining a rank of relevancy of each of the retrieved first thumbnail image and second thumbnail image based on the first value and the second value; and
displaying the retrieved first thumbnail image and second thumbnail image according to the determined ranks.

12. The computer program according to claim 8, wherein the data identifying the online article comprises at lease one of a title of the online article, a name of a journal in which the online article is published, an uniform resource locator of the online article, a digital object identifier of the online article, a PubMed identifier of the online article, and a MeSH code of the online article.

13. The computer program according to claim 8, wherein the search term is selected from terms indicating findings, diseases, anatomy, imaging modality, ages, and sexes.

14. The computer program according to claim 10, wherein the imaging modality is determined based on a frequency of appearances of a word in the figure caption, the word indicating imaging modality.

15. A system for retrieving images from online journals, comprising:
a database;
an online source module configured to select online sources that publishes online articles, collect an online article which includes a figure from the selected online sources, record data identifying the collected online article, create a thumbnail image of at least a part of the figure, store the thumbnail image and a figure caption associated with the figure in a database;
an indexing module configured to index a text of the figure caption by keywords and index the text of the figure caption by concepts obtained by using a thesaurus in a Unified Medical Language System;
a user interface configured to provide a search term;
a search module configured to determine a concept of the search term by using the thesaurus in the Unified Medical Language System, identify a first figure caption, at least one of keywords indexing a text of the first figure caption corresponding to the search term, retrieve from the database a first thumbnail image associated with the first figure caption, identify a second figure caption, at least one of concepts indexing a text of the a second figure caption corresponding to the concept of the search term, retrieve from the database a second thumbnail image associated with the second figure caption, and provide a link to an online article which includes the first figure caption with the first thumbnail image and a link to an online article which includes the second figure caption with the second thumbnail image; and
a display displaying the retrieved first thumbnail image, at least a part of the first figure caption, the retrieved second thumbnail image, and at least a part of the second figure caption.

16. The system according to claim 15, wherein the index module is configured to provide each keyword index code corresponding to each keyword indexing a text of each figure caption included in each collected online article, and provide each concepts index code corresponding to each concept indexing the text of each figure caption included in each collected online article, and
wherein the search module is configured to provide a search term code corresponding to the search term, and prove a concept search term code corresponding to the concept of the search term,
wherein the first figure caption is identified by comparing the search term code with the each keyword index code indexing the text of each figure caption included in each collected online article, and the second figure caption is identified by comparing the concept search term code with each concept index code indexing the text of each figure caption included in each collected online article.

17. The system according to claim 15, wherein the online source module is configured to determine at least one of an age and a sex of a subject of the figure using the figure caption, determine imaging modality corresponding to the figure using the figure caption, store the at least one of the age and the sex determined and the determined imaging modality in the database,
wherein the user interface is configured to enter a filtering parameter, the filtering parameter comprising at least one of an age range, a sex, and imaging modality,
wherein the search module is configured to filter the first thumbnail image and second thumbnail image based on the filtering parameter, and
wherein the display displays filtered thumbnail image.

18. The system according to claim 17, wherein the search module is configured to determine a first value indicating relevancy between the search term and the at least one of keywords indexing the text of the first figure caption, determine a second value indicating relevancy between the concept of the search term and each concept indexing the second figure caption, and determine a rank of relevancy of each of the retrieved first thumbnail image and second thumbnail image based on the first value and the second value, and
wherein the display displays the retrieved first thumbnail image and second thumbnail image according to the determined ranks.

19. The system according to claim 15, wherein the data identifying the online article comprises at lease one of a title of the online article, a name of a journal in which the online article is published, an uniform resource locator of the online article, a digital object identifier of the online article, a PubMed identifier of the online article, and a MeSH code of the online article.

20. The system according to claim 15, wherein the search term is selected from terms indicating findings, diseases, anatomy, imaging modality, ages, and sexes.

21. The system according to claim 17, wherein the imaging modality is determined based on a frequency of appearances of a word in the figure caption, the word indicating imaging modality.
